(19) United States
(12) Patent Application Publication
(10) Pub. No.: US 2003/0120819 A1
(43) Pub. Date: Jun. 26, 2003

(54) Active-active redundancy in a cable modem termination system

(76) Inventors: Howard D. Abramson, North Easton, MA (US); Mitchell Auster, Hopkinton, MA (US)

Correspondence Address: LEFFERT JAY & POLGLAZE, P.A., P.O. BOX 581009, MINNEAPOLIS, MN, 55458-1009, US

(21) Appl. No.: 10/027,781

(22) Filed: Dec. 20, 2001

(51) Int. Cl. G06F 15/16

(52) U.S. Cl. 709/250; 714/41

(57) ABSTRACT

A system, method, and apparatus for active-active 1+1 redundancy for a plurality of bi-directional communication modules of a distributed point to multi-point communications network includes pairing active modules into redundancy groups for providing backup in the event of a failure. Each module is active during normal operation and may also act as a backup for at least one other module in the event of a failure. In the event of a failure, the paired operational module takes over the failed module's service domain, and the operational module continues to meet the needs of its own service domain, thus eliminating the need for passive backup modules.

### CROSS REFERENCE TO RELATED APPLICATION

This application is related to the following additional commonly assigned, co-pending application: application Ser. No. 09/632,649, entitled, “System And Method For Active-Active Redundant Cable Modem Service At Head End,” filed Aug. 4, 2000.

### TECHNICAL FIELD

The present invention is related to a bi-directional point to multi-point distributed communications system, and more particularly to a method and apparatus for providing redundancy for cable modem termination system modules used in a system for delivering data service to end-users via cable, fiber optic or hybrid cable fiber networks.

### BACKGROUND INFORMATION

Cable operators today are deploying cable modem technology that allows subscribers to access the Internet over the same wires that deliver television signals, at speeds 100 times faster than standard V.90 telephone modem technology and without waiting for a dial-up connection.

In 1996, several cable operators commissioned the development of the data over cable service interface specification (DOCSIS) with the objective of establishing a single specification for equipment. DOCSIS covers all operational elements used in delivering dat service to end-users, including service provisioning, security, data interfaces and radio frequency interfaces (RFI).

The architecture of the DOCSIS RFI consists of three major components: the cable modem termination system (CMTS), installed at the head end, or main facility of the cable operator, the hybrid fiber coaxial (HFC) cable network wiring infrastructures; and the customer cable modems, installed at the customers' premises.

Cable modems translate digital data packets into radio frequency signals that are mapped into an unused 6 MHz television channel slot and broadcast to all homes by the CMTS modules at the HFC node. The signal is received in homes by any cable modems on the local area network segment. The downstream signal can be mapped anywhere in the downstream cable spectrum, from 91 MHz 857 MHz.

The CMTS modules of the cable operator's facility receive signals from the downstream cable modems on a different set of upstream frequencies in the 5 MHz to 42 MHz band. The throughput of this channel is variable, based on the quality of the upstream channel. Throughput varies from 160 kbps 10 Mbps. The DOCSIS architecture provides for one downstream channel to send signals to all cable modems, which may broadcast return signals on several different, nonoverlapping frequencies.

The cable modem translates the downstream radio frequency signal into packets, determines if the packets are destined for that particular cable modem and, if so, it sends the packets along to the computer or a local area network on the client side of the cable modem. This network connection may be 10/100 Mbps Ethernet, universal serial bus (USB) or PCI.

A cable operator facility typically includes one or more head end switches, which include a number of CMTS modules, typically 12. Reliable operation of the head end CMTS modules is essential to providing uninterrupted service to customers. Redundancy or backup is a key component to providing highly reliable service. In the event that one or more of the CMTS cards does fail, then the outage time to the customers should be minimized.

Perhaps the most important components to redundancy at the headend are the CMTS modules because of their role in communicating with cable modems at the customer premise and vice versa. Pure one-to-one, active-passive redundancy allows a hot standby “passive” CMTS to take over if the active CMTS fails. This type of redundancy has been used for DOCSIS 1.0-based cable modem systems because DOCSIS 1.0 provides no direct support for CMTS failure. DOCSIS 1.1 permits cable modems to be aware of a backup CMTS and gives instructions about how to locate the backup if necessary. Thus, a passive backup may serve more than one active CMTS. The problem with passive redundancy however is that it requires passive backup CMTS modules, i.e., CMTS modules that function only to provide backup to active online modules. The use of passive backup CMTS modules adds significantly to the cost of the headend switch.

The present invention addresses the foregoing problems, at least in part, as well as other problems, which will be understood by reading and studying the following specification.

### BRIEF DESCRIPTION OF THE DRAWINGS

FIG. 1 is a block diagram of downstream operation of a CMTS redundant system in normal operation, according to an example of the present invention.

FIG. 2 is a block diagram of upstream operation of a CMTS redundant system operating in response to a CMTS failure condition, according to an example of the invention.

FIG. 3 is a block diagram of upstream port configuration of a CMTS redundant system in normal operation according to an example of the invention.

FIG. 4 is a block diagram of upstream port configuration of a CMTS redundant system in response to a CMTS failure condition according to an example of the invention.

FIG. 5 is a block diagram of downstream port configuration of a CMTS redundant system in response to a CMTS failure condition according to an example of the invention.

FIG. 6 is a block diagram of an alternative upstream port configuration of a CMTS redundant system in normal operation according to an example of the invention.

FIG. 7 is a block diagram of an alternative upstream port configuration of a CMTS redundant system in response to a CMTS failure condition according to an example of the invention.

### DETAILED DESCRIPTION

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

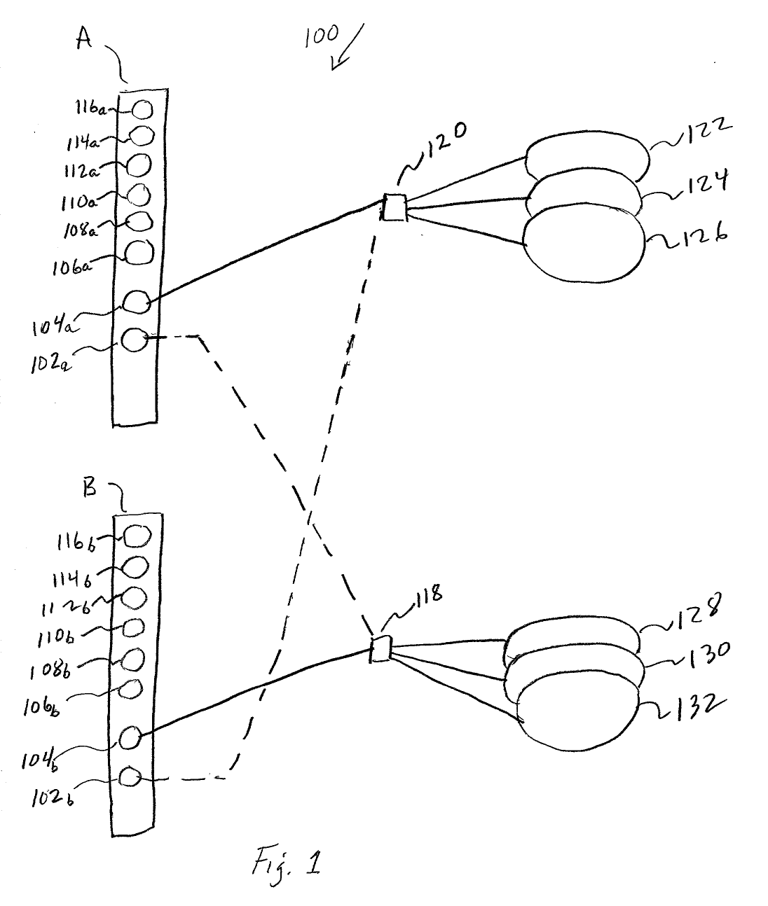

FIG. 1 shows a downstream configuration of a representative CMTS redundancy group or pair 100 according to the present invention. Although only two CMTS modules are shown, a typical headend switch may include 5 or more pairs of CMTS modules as well as other related hardware, depending on design requirements. CMTS modules A and B are identical from a hardware standpoint. CMTS modules A and B each include two outputs, 102a and 104a of CMTS module A and 102b and 104b of CMTS module B. Outputs 102a and 104a are downstream RF outputs of the transmitter of module A and outputs 102b and 104b are downstream RF outputs of the transmitter of module B. Output 104a functions as the primary output of the transmitter of module A and output 102a serves as the secondary output of module A when module B fails. Output 104b functions as the primary RF output of the transmitter of module B and output 102b serves as the secondary output of module B when module A fails. The primary output 104a of module A is merged with the secondary output 102b of module B through RF combiner 120. RF combiner 120 feeds the downstream signals to service areas 122, 124 and 126 of the cable modem system. The primary output 104b of module B is merged with the secondary output 102a of module A through RF combiner 118. RF combiner 118 feeds the downstream signals to service areas 128, 130 and 132 of the cable modem system. During normal operation, modules A and B use their primary outputs only. When one module in a redundancy pair fails, the other module enables its secondary output so that its output signal is provided to both primary and secondary service areas.

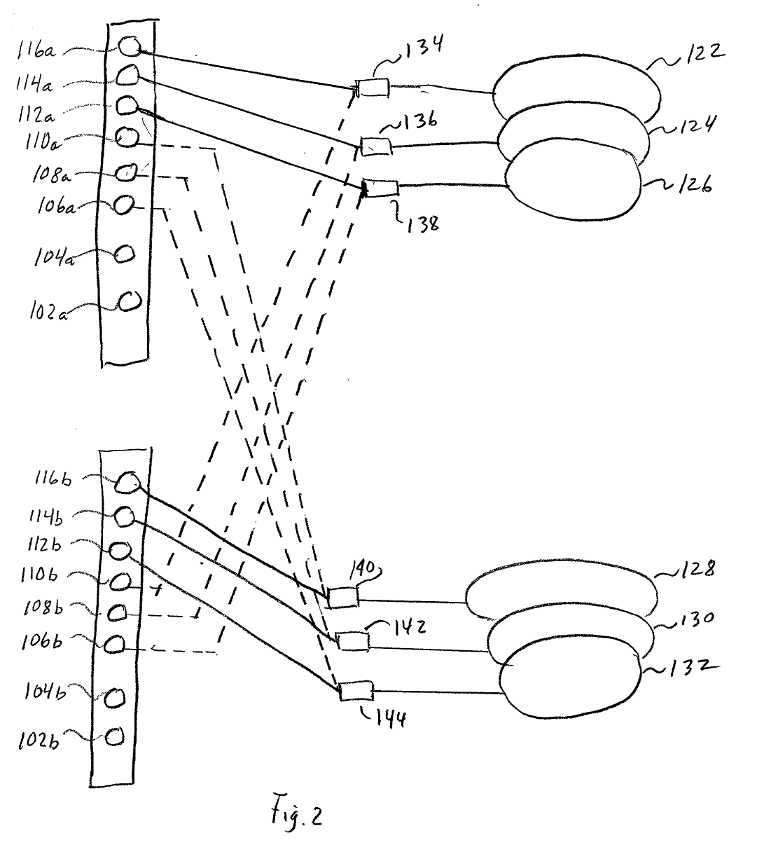

FIG. 2 shows an upstream configuration of a CMTS redundant system 100 according to the present invention. Upstream redundancy for module A is provided as follows. An upstream link from service area 122 passes through splitter 134 before it is provided to input port 116a of module A. Splitter 134 also feeds an upstream link from service area 122 to input port 110b of module B. An upstream link from service area 124 passes through splitter 136 before being provided to input port 114a of module A. Splitter 136 also feeds an upstream link from service area 124 to input port 108b of module B. An upstream link from service area 126 passes through splitter 138 before it is provided to input port 112a of module A. Splitter 138 also feeds an upstream link from service area 126 to input port 106b of module B.

Upstream redundancy for module B is provided as follows. The upstream link from service area 128 passes through splitter 140 before it is provided to input port 116b of module B. The upstream link from service area 128 is also provided by splitter 140 to input port 110a of module A. The upstream link from service area 130 passes through splitter 142 before it is provided to input port 114b of module B. The upstream link from service area 130 is also provided by splitter 142 to input port 108a of module A. The upstream link from service area 132 passes through splitter 144 before it is provided to input port 112b of module B. The upstream link from service area 132 is also provided by splitter 144 to input port 106a of module A.

Each one of the upstream receivers of CMTS modules A and B may be configured to receive signals from any one or more of the input ports. Thus, modules A and B may be configured to accept signals from primary service areas in normal operating mode and both primary and secondary service areas in failover mode of operation. For example, module A may accepts signals from its own service areas 122, 124 and 126 and also accepts the signals from CMTS module B's service areas 128, 130 and 132.

In a normal operation mode, either multiple upstream channels or a single upstream channel may be mapped to an input port. If multiple upstream channels are mapped to a single input port, each channel can be configured to use a different frequency. For example, on input port 116a, an upstream channel from service area 122 may be configured to use a frequency of 20 MHz and another upstream channel from service area 122 may be configured to use a frequency of 31 MHz, for both normal operation and failover operation.

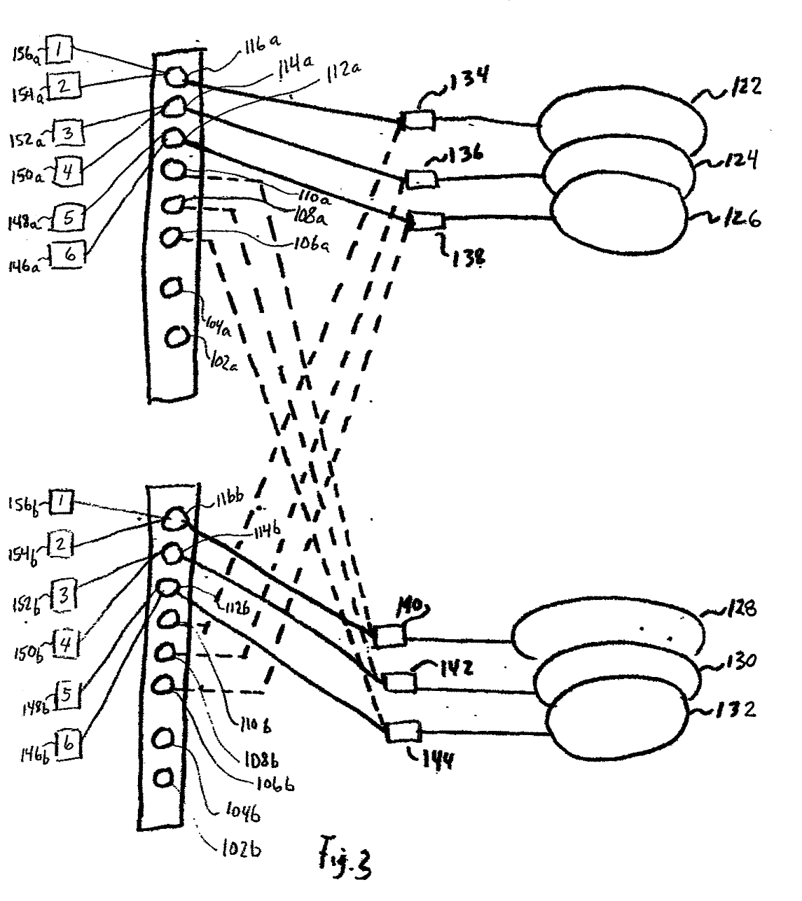

FIG. 3 shows one example of upstream port configuration in a normal mode of operation. Each upstream receiver is configured to receive a different upstream channel. In this example, the channels are designated as channels 1 through 6. Upstream receivers 156a (channel 1) and 154a (channel 2) are mapped to port 116a, upstream receivers 152a (channel 3) and 150a (channel 4) are mapped to port 114a and upstream receivers 148a (channel 5) and 146a (channel 6) are mapped to port 112a of CMTS module A. Similarly, with regard to module B, upstream receivers 156b (channel 1) and 154b (channel 2) are mapped to input port 116b, upstream receivers 152b (channel 3) and 150b (channel 4) are mapped to input port 114b and upstream receivers 146b (channel 5) and 148b (channel 6) are mapped to input port 112b. This approach to port mapping maximizes the capacity of the modules, since all upstream receivers are used.

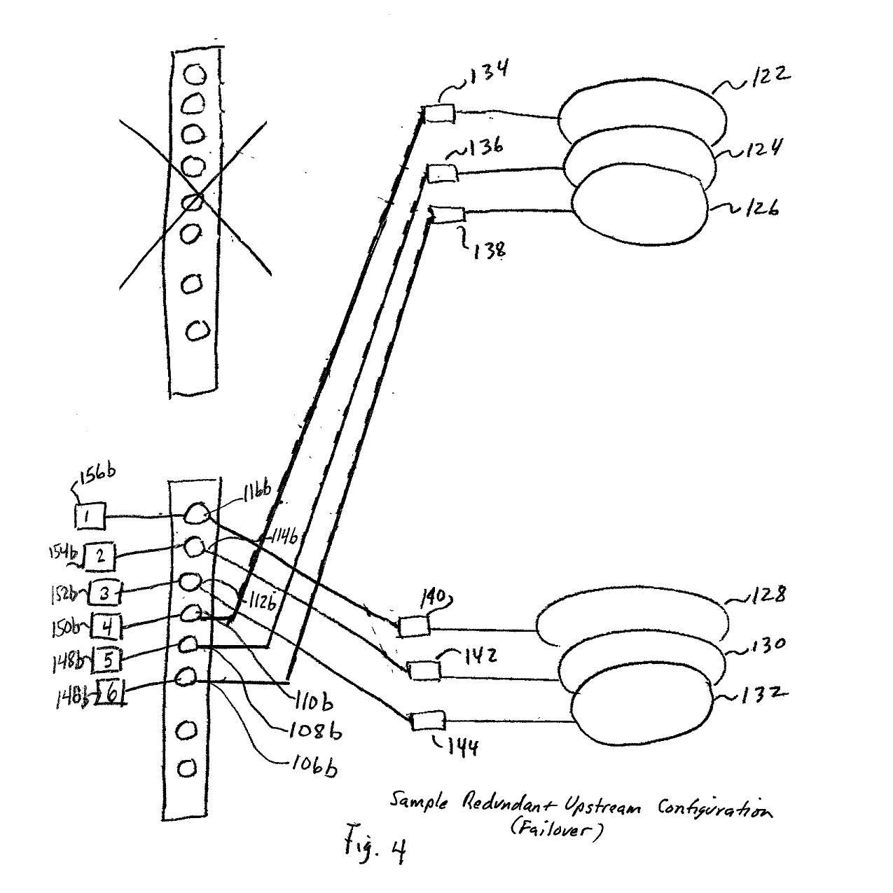

FIG. 4 shows one example of upstream port configuration in a failover mode of operation. In this example, module A has failed and all upstream traffic has been switched over to module B. Module B must now provide coverage as follows. Upstream Channel 1, which used port 116b under normal operation, continues to use port 116b. Cable modems in service area 128 that used upstream Channel 1 under normal conditions are unaffected. Upstream Channel 2, which used port 116b under normal operation, now uses port 114b. Cable modems in service area 128 that normally used upstream channel 2 switch over to upstream Channel 1. Upstream Channel 3, which used to port 114b under normal operation, now uses port 112b. Cable modems in service area 130 that normally use upstream Channel 3 switch over to upstream Channel 2. Upstream Channel 4, which used port 114b under normal operation, now uses port 110b, providing service to cable modems in service area 122 that were previously served by the failed module. Cable modems in service area 130 that normally use upstream Channel 4 switch over to upstream Channel 2 on port 114b. Upstream Channel 5, which used port 112b under normal operation, now uses port 108b providing service to cable modems and service area 124 that were previously served by the failed module. Cable modems and service area 132 that normally use upstream Channel 5 switch over to upstream Channel 3 on port 112b. Upstream Channel 6, which used upstream physical port 112b under normal operation, now uses upstream physical port 106b, providing service to cable modems and service area 126 that were previously served by the failed module. Cable modems in service area 132 that normally use upstream channel 6 switch over to upstream Channel 3 on port 112b.

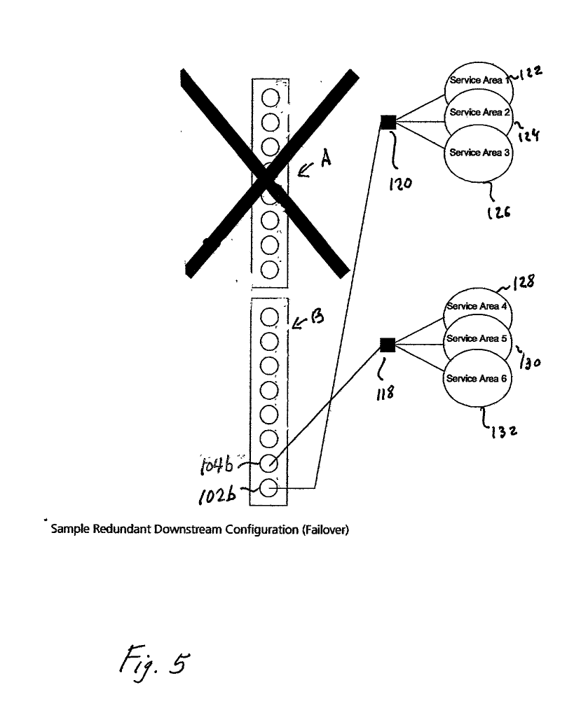

Unlike upstream ports, downstream port mappings are not reconfigured for a failover. FIG. 5 shows a sample redundant downstream configuration in the event of a failover. Downstream port 104b of module B provides service to service areas 128 130 and 132. Downstream port 102b provides service to service areas 122, 124 and 126 which were previously served by the failed module.

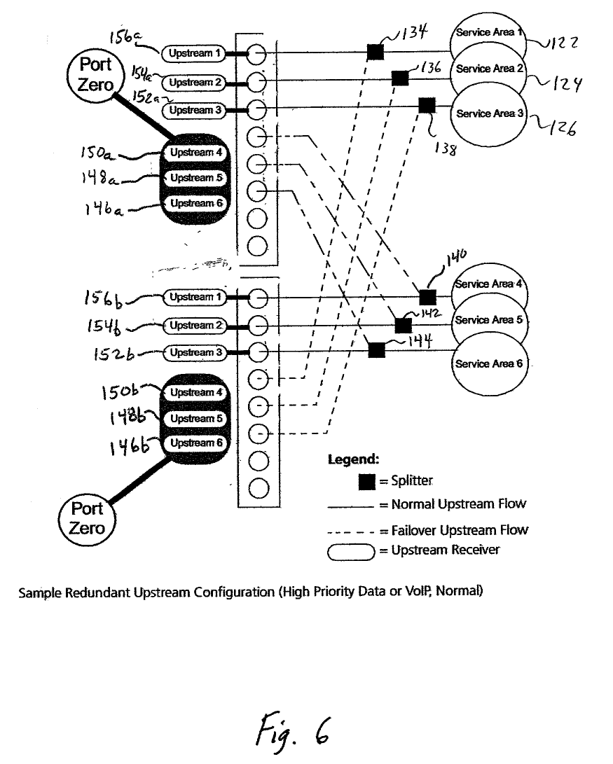

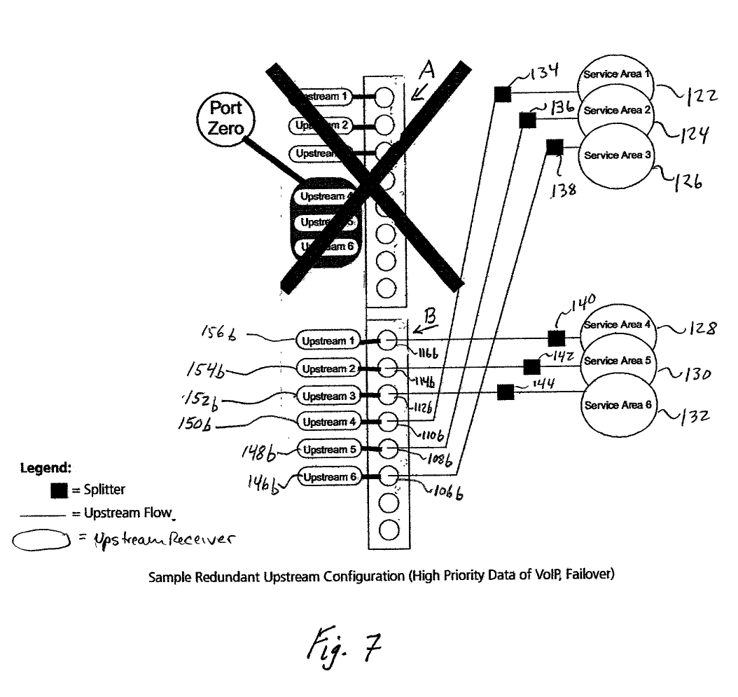

Various other redundant port configurations are possible depending on system requirements. FIG. 6 shows one example of a redundant upstream port configuration designed to meet the needs of a high priority data or voice over IP application. The configuration of FIG. 6 maps and single upstream channel to each port. While this approach to port mapping does not maximize the capacity of the module under normal conditions, since not all upstream channels are used, it provides for at least some of module capacity (50 percent) in the event that the other module in the group fails. It also assures that cable modems on upstream channels and 1 2 and 3 will continue to operate when the other module fails. FIG. 7 shows a sample redundant upstream configuration for a high-priority data or voice over Internet application in the event of a failover. Upstream receiver 156b (channel 1), which used upstream port 116b under normal operation continues the use port 116b. Cable modems and service area 128 the used upstream Channel 1 under normal conditions are unaffected. Upstream receiver 154b (channel 2), which used upstream physical port 114b under normal operation continues to use port 114b cable modems and service area 130 that used upstream channel 2 under normal conditions are unaffected. Upstream receiver 152b (channel 3), which used upstream physical port 112b under normal operation continues to use port 112b. Cable modems in service area 130 that used upstream Channel 3 under normal conditions are unaffected. Upstream receiver 150b (channel 4) on port 110b provides service to cable modems in service area 122 that were previously served by the failed module. Upstream receiver 148b (channel 5) on port 108b provides service to cable modems and service area of 124 there were previously served by the failed module. Upstream receiver 146b (channel 6) on port 106b provides service to cable modems and service area 126 set were previously served by the failed module.

In order to determine whether a CMTS module is working properly, in one example, the CMTS modules may communicate directly with each other by sending a signal that indicates the unit is functioning normally to the other unit in the redundancy pair. This signal, may be a simple “heartbeat” that is sent periodically, for example, every second, to let the other card know that everything is normal and no backup services are required. Alternatively, the signal may include telemetry or failure codes to more particularly identify the nature and extent of the failure. In the event that the signal ceases or indicates a condition other than normal, the backup module may take over immediately for the failed module (failover), perform further diagnostics such as sending a heartbeat request, and/or attempt to bring the failed module back online by rebooting, for example.

Another way to determine whether a failover event has occurred is for each module to provide a signal to a controller which will supervise the failover process to ensure that there is an appropriate response sequence to minimize downtime.

In order to provide an optimal backup operation according to the present invention that is compatible with the DOCSIS protocol, the cable modems in the affected service areas need to have a downstream and an upstream signal to maintain connectivity with the CMTS. The problem of maintaining connectivity is presented both during the failover/takeover process and during the recovery/giveback process.

Timing for substituting the downstream signal for a failed module must consider requirements of the DOCSIS protocol. When a cable modem loses downstream synchronization with the CMTS, the DOCSIS protocol specifies that the cable modem should reset and attempt to establish connectivity. The exact way this occurs depends on the version of DOCSIS. DOCSIS 1.00 cable modems were originally specified to immediately reset and attempt to re-establish connectivity is downstream synchronization were lost. Changes to the DOCSIS specification, to support more reliable system operation overall, now specify that cable modems should wait between 30 and 35 seconds before reset. This added delay is further complicated by variability in transmission time between the CMTS and each cable modem due, for example, to distance, ambient conditions, wiring, differences in the design and manufacture of cable modems, and other like considerations. Several approaches are available to minimize the loss of connectivity.

Whenever a CMTS module loses upstream signals from a cable modem, the CMTS is specified, by the DOCSIS protocol, to terminate the ranging process. The ranging process is the mechanism used to ensure correct power and frequencies are selected when the cable modem transmits data upstream. Loss of the ranging opportunities is interpreted by the cable modem as a loss in connectivity. Thus, the cable modem will reset when it detects that ranging opportunities are no longer available.

The ability to internally combine and split upstream signals from the Cable Modem network into the CMTS greatly reduces expense, effort and cabling. However, it is possible to configure normal and failover port maps such that more than one CMTS module's cable modems are affected by a CMTS failure and recovery. For example, port maps may be defined such that a failed module results in almost all the cable modems losing upstream connectivity and resetting. Only Cable Modems on upstream channel 1 and port 1 will remain connected during the takeover (failover) process. The problem is not in the configuration, rather, the problem is in the change between normal and failover port maps. A mechanism is needed to instruct cable Modems connected to the good (takeover) module to move upstream channels before a change is made to the port maps. This “Upstream Channel Change” or “Dynamic Channel Change” is a standard mechanism in the DOCSIS protocol and permits the cable modem to remain connected during a change to the upstream port mappings.

One approach to address control of downstream transmission and upstream reception when the CMTS recovers or fails over is to create an independent state machine or controller within the CMTS to handle the timing whenever a failover or recovery takes place. A first such state machine may be used to determine the health of a CMTS module's redundancy peer. Such a redundancy protection switch (RPS) state machine maintains information about the status of the module and its peer. As such, each module knows what and how the other module is doing. Timing of takeover and giveback operations may be configured by an operator to account for differences in modems so that a takeover or recovery does not conflict with a change in the upstream port mappings.

A second state machine (IntfPortMgr) may be used to control the status of the downstream transmitter and upstream port mappings. The RPS and IntfPortMgr are designed to be independent and cooperative. This cooperation permits user configurable control of the downstream transmitter and upstream receivers. As such, downstream transmission during a failover (or recovery) is governed by a user configurable parameter to provide optimal interoperability with different DOCSIS Cable Modem types. Similarly, upstream channel change is provided during the failover/takeover and recovery/giveback operations. This permits the good CMTS module to maintain connectivity with the cable modems during a change in port mappings. For example, when upstream channel 1 and 2 are mapped to physical port 1, any change (i.e., takeover or giveback) that forces channel 2 to a different port will result in Cable Modems on channel 2 losing connectivity. This can be avoided by first instructing the Cable Modems to move to channel 1 and then changing the port mapping for channel 2 to use a port other than number 1.

### Conclusion

A system, method, and apparatus for active-active 1+1 redundancy for a plurality of CMTS modules has been detailed. Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A system comprising:
a first bi-directional communications module that provides primary service to one or more first service areas in a distribution network and backup service to one or more second service areas; and
a second bi-directional communications module that provides primary service to one or more of the second service areas and backup service to one or more of the first service areas,
wherein the first and second bi-directional communications modules comprise a redundancy group.

2. The system of claim 1 wherein each module comprises a primary and a secondary downstream output and wherein the primary downstream output is combined with a secondary downstream output of at least one other bi-directional communications module in the event of a failure of the at least one other bi-directional communications module.

3. The system of claim 1 wherein each module comprises a plurality of upstream ports and a plurality of upstream receivers mapped to one or more of the upstream ports, wherein a remapping of one or more upstream receiver takes place in the event of a failure of the at least one other bi-directional communications module.

4. A system comprising:
a first cable modem termination system module that provides primary service to one or more first service areas and backup service to one or more second service areas; and
a second cable modem termination system module that provides primary service to one or more of the second service areas and backup service to one or more of the first service areas,
wherein the first and second cable modem termination system modules comprise a redundancy group.

5. The system of claim 4 wherein each module comprises a primary and a secondary downstream output and wherein the primary downstream output is combined with a secondary downstream output of at least one other cable modem termination system module in the event of a failure of the at least one other cable modem termination system module.

6. The system of claim 5 wherein the primary downstream output is combined with a secondary downstream output of at least one other cable modem termination system module by an RF combiner.

7. The system of claim 4 wherein each module comprises a plurality of upstream ports and a plurality of upstream receivers that may be configured to receive data on one or more upstream channels.

8. A system comprising one or more pairs of cable modem termination system modules wherein both modules of a pair in a normal mode of operation provide primary service to at least one service area and also provide backup service in a backup mode of operation for at least one additional service area in the event of a failure of the module to which it is paired and in addition to continuing to provide primary service to the at least one service area.

9. A system comprising:
a first bi-directional communications module that provides primary upstream and downstream service to one or more first service areas, and secondary upstream and downstream service to one or more second service areas, the first bi-directional communications module comprising
a plurality of upstream ports linked to a plurality of the first and second secondary service areas, and
a plurality of upstream receivers mapped to one or more of the upstream ports;
a first downstream port to provide downstream service to the one or more of the first service areas;
a second downstream port to provide backup downstream service to the one or more of the second service areas;
a status indicator to provide an indication of an operating status of the first bi-directional communications module to a secondary bi-directional communications module; and
a second bi-directional communications module that provides primary upstream and downstream service to one or more of the second service areas, and secondary upstream and downstream service to one or more of the first service areas, second bi-directional communications module comprising
a plurality of upstream ports linked to a plurality of first and second service areas, and
a plurality of upstream receivers mapped to one or more of the upstream ports;
a first downstream port to provide downstream service to the one or more second service areas;
a second downstream port to provide backup downstream service to the one or more first service areas; and
a status indicator to provide an indication of an operating status of the second bi-directional communications module to the first bi-directional communications module.

10. The system of claim 9 wherein a remapping of one or more upstream receivers of the first bi-directional communications modules to effect upstream service to the one or more second service areas takes place in response to an indication that the second bi-directional communications module has failed; and
a remapping of one or more upstream receivers of the second bi-directional communications modules to effect upstream service to the one or more first service areas takes place in response to an indication that the first bi-directional communications module has failed.

11. The system of claim 10 wherein the system is a DOCSIS compliant hybrid fiber cable system.

12. A bi-directional multi-point to point communication system, comprising:
a distribution network;
a plurality of end user cable modems that transmit and receive data over the distribution network;
at least one head end terminal comprising
a plurality of modules to transmit downstream data in a first frequency bandwidth over the distribution network and to receive upstream data in a second frequency bandwidth over the distribution network,
wherein a first module of the plurality of modules provides primary service to one or more first service areas in the distribution network in a normal mode of operation and provides backup service to one or more second service areas in the distribution network in a backup mode of operation while continuing to provide primary service to the one or more first service areas; and
wherein a second module provides primary service to one or more of the second service areas in the distribution network in a normal mode of operation and backup service to one or more of the first service areas in the distribution network in a backup mode of operation while continuing to provide primary service to the one or more second service areas.

13. The system of claim 12, further comprising a controller to supervise timing of a change to a backup mode of operation.

14. The system of claim 13, wherein the controller is configured to enable modems to reconfigure upstream channels before a change is made to port maps in response to the change to a backup mode of operation.

15. The system of claim 12, wherein a change to a backup mode of operation of a module is initiated in response to an indication of failure from the module that provides primary service.

16. A method of providing back up service in a bi-directional multi-point to point distribution network for a first module that transmits downstream data in a first frequency bandwidth over the distribution network and receives upstream data in a second frequency bandwidth over the distribution network, comprising:
pairing the first module with a second module to form a redundancy group wherein the first module provides primary service to one or more first service areas in the distribution network in normal operation and backup service to one or more second service areas in the distribution network in a backup mode of operation and the second module provides primary service to one or more of the second service areas in the distribution network in normal operation and backup service to one or more of the first service areas in the distribution network in a backup mode of operation.

17. The method of claim 16, wherein the first and second modules each communicate a status signal to the other module of the pair indicating an operating status of the module.

18. The method of claim 17, wherein the signal comprises a heartbeat.

19. The method of claim 17 wherein a backup mode of operation of one module of the pair will begin in response to a change in the status signal of the other module of the pair.

20. The method of claim 19 wherein timing of the backup operation is configurable by an operator.

21. The method of claim 19 wherein timing of the backup operation is configurable to enable modems to reconfigure upstream channels before a change is made to port maps in response to the change to a backup mode of operation.
